(19) United States
(12) Patent Application Publication
(10) Pub. No.: US 2025/0135359 A1
(43) Pub. Date: May 1, 2025

(54) SYSTEM, METHOD, PROGRAM, AND DEVICE FOR GAME IN WHICH GAME MEDIUM COMPOSITION IS PERFORMED

(71) Applicant: CYGAMES, INC., Tokyo (JP)

(72) Inventors: Sho Kumamoto, Tokyo (JP); Satoshi Hiroshima, Tokyo (JP); Chiaki Mizuochi, Tokyo (JP)

(73) Assignee: CYGAMES, INC., Tokyo (JP)

(21) Appl. No.: 19/009,434

(22) Filed: Jan. 3, 2025

Related U.S. Application Data
(63) Continuation of application No. PCT/JP2023/023946, filed on Jun. 28, 2023.

(30) Foreign Application Priority Data
Jul. 13, 2022 (JP) 2022-112570

(51) Int. Cl. A63F 13/822; A63F 13/52

(52) U.S. Cl. CPC A63F 13/822; A63F 13/52

(57) ABSTRACT

Provided is a system for a game in which game medium composition is performed. The system stores a first-type game medium group, a second-type game medium group, first-type composition information indicating compositions each including two or more first-type game media selected from among first-type game media, second-type composition information indicating compositions each including two or more second-type game media selected from among second-type game media, a first-type composition information group including two or more items of first-type composition information, and a second-type composition information group including two or more items of second-type composition information; displays a composition image showing a first composition area and a second composition area.

### TECHNICAL FIELD

The present invention relates to systems, etc. for a game in which game medium composition is performed. In particular, the present invention relates to a system, etc. for a game in which content is executed by using a game medium composition including a plurality of game media.

### Background Art

Among recent online games, etc., there are game systems that make it possible for a player to play two or more types of content, namely, normal content and special content, within a single game (Patent Literature 1).

### CITATION LIST

### Patent Literature

### PTL 1

Japanese Unexamined Patent Application, Publication No. 2022-073124

### SUMMARY OF INVENTION

### Technical Problem

In the case where there are a plurality of types of content in a game in which content is executed by using a game medium composition including a plurality of game media, with a composition including characters, items, etc. that can be used only in special content as well as characters, items, etc. that are used in normal content, it is possible to play content by using a composition different from that for a normal quest. In such cases, it is necessary to create a composition that is used only in special content in addition to a composition that is used in normal content, which results in the problem that laborious player operations are required.

The present invention has been made in order to solve the problem described above, and it is a main object thereof to provide a system for a game in which it is possible to perform game medium composition with operations that are easier for players.

### Solution to Problem

1. In order to achieve the above object, a system according to an embodiment of the present invention is a system for a game in which content is executed by using a game medium composition including a plurality of game media, wherein: the system stores a first-type game medium group including two or more first-type game media, a second-type game medium group including two or more second-type game media, first-type composition information indicating compositions each including two or more first-type game media selected from among the first-type game media, second-type composition information indicating compositions each including two or more second-type game media selected from among the second-type game media, a first-type composition information group including two or more items of first-type composition information, and a second-type composition information group including two or more items of second-type composition information; the system displays a composition image showing a first composition area and a second composition area, the first composition area being an area for displaying selected first-type composition information selected from the first-type composition information group for the purpose of use in content, and the second composition area being an area for displaying selected second-type composition information selected from the second-type composition information group; the system changes the selected first-type composition information on the basis of a player input corresponding to the first composition area, and changes the selected second-type composition information on the basis of a player input corresponding to the second composition area; and the system executes content on the basis of the selected first-type composition information and the selected second-type composition information.
2. Furthermore, the system according to 1 may be arranged such that: the first-type game media are used in order to execute content of a first content type and content of a second content type, and the second-type game media are used in order to execute content of the second content type; the composition image is generated on the basis of content to be executed, selected by a player, and in the case where the content to be executed is first-type content, other selected first-type composition information selected from the first-type composition information group or first-type game media are displayed in the second composition area instead of the selected second-type composition information; and the execution of content is executing the content to be executed, selected by the player.
3. Furthermore, the system according to 1 or 2 may be arranged such that the content of the first content type is content that is executed on the basis of the consumption of a first parameter associated with a player, and the content of the second content type is content that is executed on the basis of the consumption of a second parameter associated with a player.
4. The system according to any one of 1 to 3 may be arranged such that the player input corresponding to the first composition area and the player input corresponding to the second composition area are the same kind of operational input.
5. The system according to any one of 1 to 4 may be arranged such that: the changing of the selected first-type composition information includes changing the selected first-type composition information to other first-type composition information in the first-type composition information group; and the changing of the selected second-type composition information includes changing the selected second-type composition information to other second-type composition information in the second-type composition information group.
6. A method according to an embodiment of the present invention is a method for a game in which content is executed by using a game medium composition including a plurality of game media, wherein a computer is caused to: store a first-type game medium group including two or more first-type game media, a second-type game medium group including two or more second-type game media, first-type composition information indicating compositions each including two or more first-type game media selected from among the first-type game media, second-type composition information indicating compositions each including two or more second-type game media selected from among the second-type game media, a first-type composition information group including two or more items of first-type composition information, and a second-type composition information group including two or more items of second-type composition information; transmit information for displaying a composition image showing a first composition area and a second composition area, the first composition area being an area for displaying selected first-type composition information selected from the first-type composition information group for the purpose of use in content, and the second composition area being an area for displaying selected second-type composition information selected from the second-type composition information group; change the selected first-type composition information on the basis of a player input corresponding to the first composition area and change the selected second-type composition information on the basis of a player input corresponding to the second composition area; and execute content on the basis of the selected first-type composition information and the selected second-type composition information.
7. A method according to another embodiment of the present invention is a method for a game in which content is executed by using a game medium composition including a plurality of game media, wherein a computer is caused to: display a composition image on the basis of information obtained from a storage medium storing a first-type game medium group including two or more first-type game media, a second-type game medium group including two or more second-type game media, first-type composition information indicating compositions each including two or more first-type game media selected from among the first-type game media, second-type composition information indicating compositions each including two or more second-type game media selected from among the second-type game media, a first-type composition information group including two or more items of first-type composition information, and a second-type composition information group including two or more items of second-type composition information, the composition image showing a first composition area and a second composition area, the first composition area being an area for displaying selected first-type composition information selected from the first-type composition information group for the purpose of use in content, and the second composition area being an area for displaying selected second-type composition information selected from the second-type composition information group; change the selected first-type composition information on the basis of a player input corresponding to the first composition area and change the selected second-type composition information on the basis of a player input corresponding to the second composition area; and execute content on the basis of the selected first-type composition information and the selected second-type composition information.
8. A program according to an embodiment of the present invention causes a computer to execute a method according to 6 or 7.
9. An information processing device according to an embodiment of the present invention is an information processing device for a game in which content is executed by using a game medium composition including a plurality of game media, wherein: the information processing device stores a first-type game medium group including two or more first-type game media, a second-type game medium group including two or more second-type game media, first-type composition information indicating compositions each including two or more first-type game media selected from among the first-type game media, second-type composition information indicating compositions each including two or more second-type game media selected from among the second-type game media, a first-type composition information group including two or more items of first-type composition information, and a second-type composition information group including two or more items of second-type composition information; the information processing device transmits information for displaying a composition image showing a first composition area and a second composition area, the first composition area being an area for displaying selected first-type composition information selected from the first-type composition information group for the purpose of use in content, and the second composition area being an area for displaying selected second-type composition information selected from the second-type composition information group; the information processing device changes the selected first-type composition information on the basis of a player input corresponding to the first composition area, and changes the selected second-type composition information on the basis of a player input corresponding to the second composition area; and the information processing device executes content on the basis of the selected first-type composition information and the selected second-type composition information.
10. An information processing device according to another embodiment of the present invention is an information processing device for a game in which content is executed by using a game medium composition including a plurality of game media, wherein: the information processing device displays a composition image on the basis of information obtained from a storage medium storing a first-type game medium group including two or more first-type game media, a second-type game medium group including two or more second-type game media, first-type composition information indicating compositions each including two or more first-type game media selected from among the first-type game media, second-type composition information indicating compositions each including two or more second-type game media selected from among the second-type game media, a first-type composition information group including two or more items of first-type composition information, and a second-type composition information group including two or more items of second-type composition information, the composition image showing a first composition area and a second composition area, the first composition area being an area for displaying selected first-type composition information selected from the first-type composition information group for the purpose of use in content, and the second composition area being an area for displaying selected second-type composition information selected from the second-type composition information group; the information processing device causes the selected first-type composition information to be changed on the basis of a player input corresponding to the first composition area, and causes the selected second-type composition information to be changed on the basis of a player input corresponding to the second composition area; and the information processing device causes content to be executed on the basis of the selected first-type composition information and the selected second-type composition information.

### Advantageous Effects of Invention

The present invention makes it possible to provide a system for a game in which it is possible to perform game medium composition with operations that are easier for players.

### BRIEF DESCRIPTION OF DRAWINGS

FIG. 1 is a system configuration diagram according to an embodiment of the present invention.

FIG. 2 is a hardware configuration diagram of the system according to the embodiment of the present invention.

FIG. 3 is a functional block diagram of the system according to the embodiment of the present invention.

FIG. 4 shows an example table indicating information concerning a game medium group according to the embodiment of the present invention.

FIG. 5 shows an example table indicating information concerning a game medium group according to the embodiment of the present invention.

FIG. 6 shows an example table indicating information concerning game media according to the embodiment of the present invention.

FIG. 7 is an example table showing information concerning game media according to the embodiment of the present invention.

FIG. 8 is an example table showing information concerning a composition information group according to the embodiment of the present invention.

FIG. 9 is an example table showing information concerning a composition information group according to the embodiment of the present invention.

FIG. 10 is an example table showing stamina related information according to the embodiment of the present invention.

FIG. 11 is an example table showing event stamina values according to the embodiment of the present invention.

FIG. 12 is an example table showing event stamina values according to the embodiment of the present invention.

FIG. 13 is an example game screen according to the embodiment of the present invention.

FIG. 14 is an example game screen according to the embodiment of the present invention.

FIG. 15 is an example game screen according to the embodiment of the present invention.

FIG. 16 is a flowchart showing information processing according to the embodiment of the present invention.

FIG. 17 is an example game screen according to the embodiment of the present invention.

FIG. 18 is an example game screen according to the embodiment of the present invention.

FIG. 19 is an example game screen according to the embodiment of the present invention.

FIG. 20 is a flowchart showing information processing according to the embodiment of the present invention.

FIG. 21 is a flowchart showing information processing according to the embodiment of the present invention.

### DESCRIPTION OF EMBODIMENTS

A game system 1 according to an embodiment of the present invention will be described below with reference to the drawings. In this description, there are cases where explanations more detailed than necessary are omitted for the convenience of explanation. For example, there are cases where detailed explanations of matters already well known or repeated explanations of the same configurations are omitted.

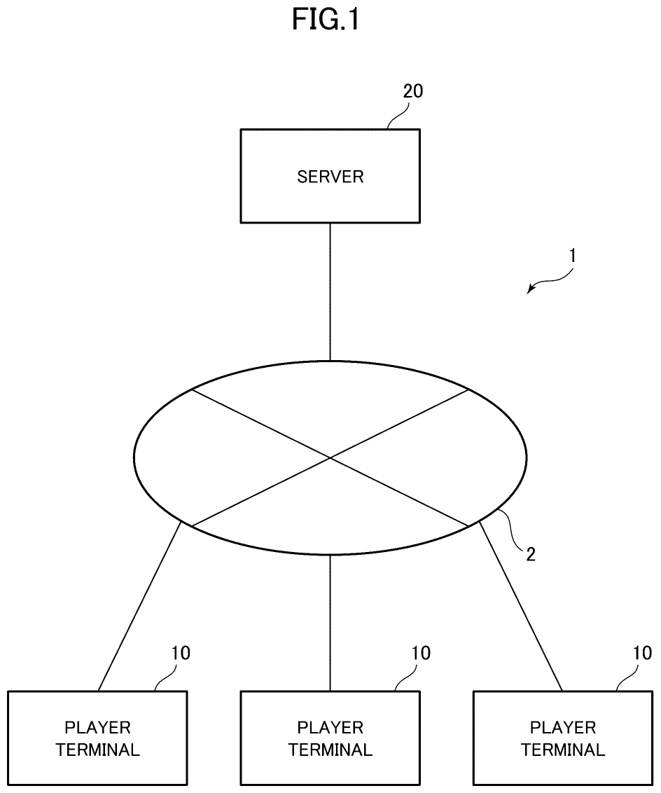

It is assumed that the game system 1 is realized by a system in which a plurality of player terminals are connected to a server via a network. FIG. 1 shows an example of the overall configuration of the game system 1 according to an embodiment of the present invention. As shown in FIG. 1, the game system 1 includes a plurality of player terminals 10 and a server 20, and the player terminals 10 and the server 20 are connected to a network 2, such as the Internet, so as to be able to communicate with each other. Note that although it is assumed in the following description that the game system 1 in this embodiment is a server-client system, the present invention can also be embodied in the form of a system in which the plurality of player terminals 10 are connected on a peer-to-peer basis or in the case where the player terminals 10 operate as stand-alone terminals without having to communicate with the server 20.

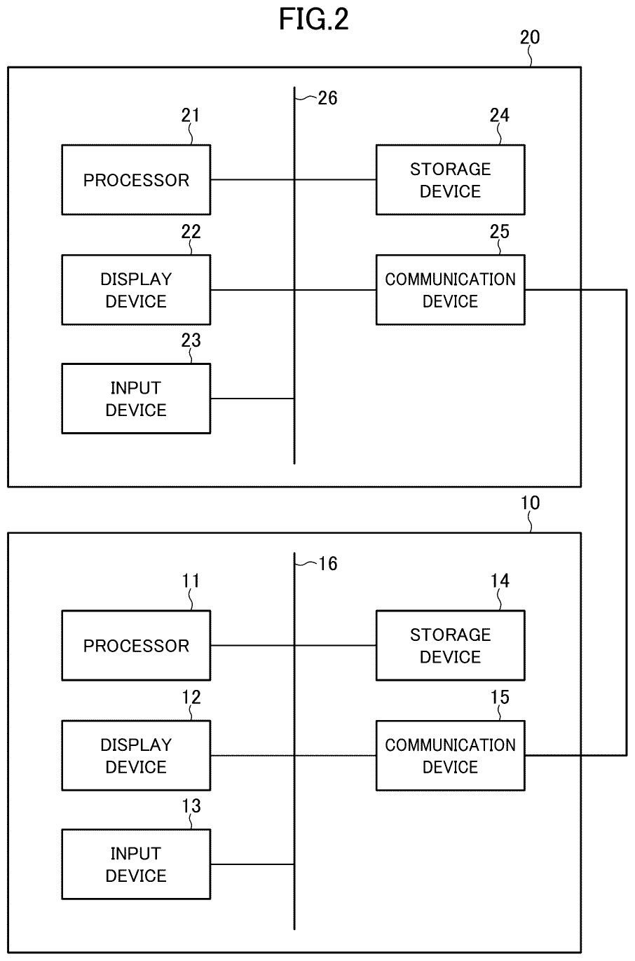

FIG. 2 is a block diagram showing the hardware configurations of each of the player terminals 10 and the server 20 according to an embodiment of the present invention. The player terminal 10 includes a processor 11, a display device 12, an input device 13, a storage device 14, and a communication device 15. These constituent devices are connected to each other via a bus 16. Note that interfaces are interposed as needed between the bus 16 and the individual constituent devices. In this embodiment, the player terminal 10 is a smartphone. Note that the player terminal 10 may be an information processing device having the configuration described above, such as a tablet computer, a personal computer, or a game device.

Similarly, the server 20 includes a processor 21, a display device 22, an input device 23, a storage device 24, and a communication device 25. These constituent devices are connected to each other via a bus 26. Note that interfaces are interposed as needed between the bus 26 and the individual constituent devices. Although the server 20 is realized by a computer in this embodiment, the server 20 may be realized by other types of information processing devices.

The processor 11 or 21 controls the overall operation of the player terminal 10 or the server 20, and for example, the processors 11 and 21 are CPUs. Alternatively, electronic circuits such as MPUs may be used as the processors 11 and 21. The processor 11 or 21 executes various kinds of processing by loading programs and data stored in the storage device 14 or 24 and executing the programs. In one example, the processors 11 and 21 are each constituted of a plurality of processors.

The display device (display) 12 or 22, under the control of the processor 11 or 21, displays application screens, etc. to a user (player) of the player terminal 10 or a user (administrator) of the server 20. Although it is assumed that the display devices are liquid crystal displays in this embodiment, the display devices may be displays utilizing organic EL, plasma displays, or the like.

The input devices 13 and 23 are user interfaces that accept inputs to the player terminal 10 and the server 20 from users, and for example, the input devices 13 and 23 are touch panels, touch pads, keyboards, or mouses. Since the player terminal 10 is a smartphone in this embodiment, the player terminal 10 includes a touch panel as the input device 13, and the touch panel also functions as the display device 12, and thus the display device 12 and the input device 13 have an integrated structure. The display device 12 and the input device 13 may be disposed in different positions in separate forms. It is assumed that the server 20, which is a computer, includes a keyboard and a mouse as input devices and a liquid crystal display as a display device.

The storage devices 14 and 24 are storage devices included in ordinary smartphones and computers, including RAMs, which are volatile memories, as well as storage media based on flash memories, such as eMMCs, UFSs, and SSDs, which are non-volatile memories, storage devices, magnetic storage devices, etc. The storage devices 14 and 24 may also include external memories. For example, the storage device 14 stores a browser program and a game program, and the storage device 24 stores a game program for the server. The browser program and the game program are activated in response to user operations on the player terminal 10 and are executed on an operating system (OS) preinstalled in the player terminal 10. The game program for the server includes functions and various kinds of data for carrying out information processing so that the game will proceed properly on the browser program and game program executed on each player terminal serving as a client. Furthermore, it is also possible to use a database physically separated from the player terminal 10 and the server 20 as a storage device.

The communication devices 15 and 25 send data to and receive data from other devices via the network 2 (not shown in FIG. 2). For example, the communication devices 15 and 25 carry out wireless communication, such as mobile communication or wireless LAN communication, to connect to the network 2. The player terminal 10 carries out communication with the server 20 via the network by using the communication device 15. The communication devices 15 and 25 may carry out wired communication using an Ethernet (registered trademark) cable or the like.

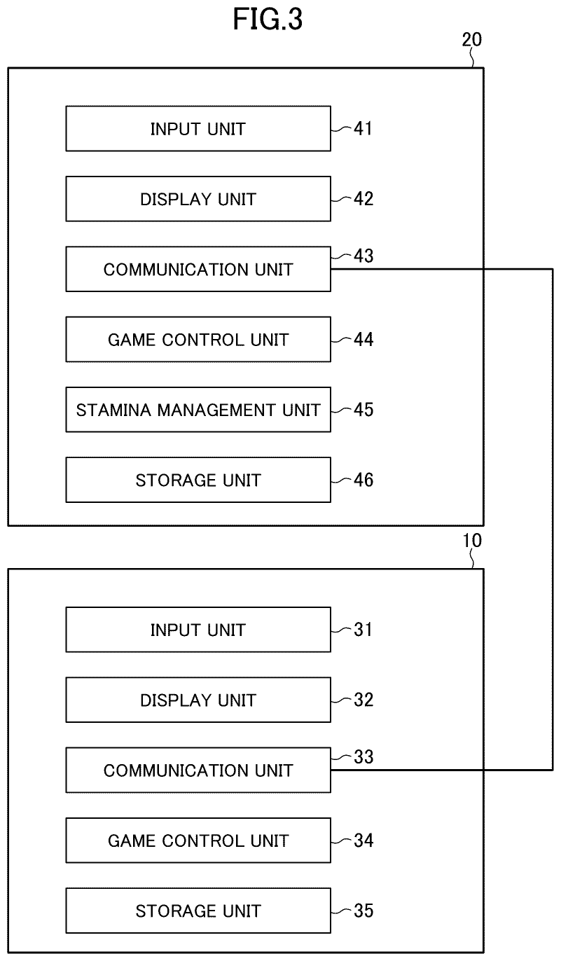

FIG. 3 shows an example functional block diagram of the player terminal 10 and the server 20 according to an embodiment of the present invention. The player terminal 10 includes an input unit 31, a display unit 32, a communication unit 33, a game control unit 34, and a storage unit 35, and the server 20 includes an input unit 41, a display unit 42, a communication unit 43, a game control unit 44, a stamina management unit 45, and a storage unit 46. In this embodiment, these functions are realized by the processors 11 and 21 executing programs. For example, the programs that are executed are the browser program and the game program stored in the storage devices 14 and 24. Since various kinds of functions are realized by loading programs, as described above, one part (function) may be provided in another part in part or in entirety. These functions may also be realized by means of hardware by configuring electronic circuits or the like for realizing the individual functions in part or in entirety.

The input units 31 and 41 are configured by using the input devices 13 and 23 and accept inputs to the player terminal 10 and the server 20 from users. The player terminal 10 and the server 20 accept user inputs via the input units 31 and 41. For example, the user inputs may include command inputs indicating instructions from players in the game. In this embodiment, at the player terminal 10, it is possible to use a touch detection function, which is generally provided in a smartphone equipped with a touch panel.

The display unit 32 of the player terminal 10 displays game screens by using the display device 12 to display game screens in accordance with the proceeding of the game and user operations. The display unit 42 of the server 20 displays management screens for the game administrator on the display device 22 as needed.

The game control units 34 and 44 stores control processing for executing the game in this embodiment, as well as various kinds of data necessary for the processing, in the storage units 35 and 46. In this embodiment, the game control unit 34 of the player terminal 10, which is realized by using a browser program, processes information input from or output to the user, processes signals transmitted to or received from the server 20, and so forth. The game control unit 34 may be realized by installing a game application (app) in the player terminal 10.

The game control unit 44 of the server 20, which is realized by executing a server game program, carries out processing for the game executed at the player terminal 10. In one example, when a browser is activated at the player terminal 10, whereby the game control unit 34 is realized, and the browser accesses the server 20 in order to proceed with the game, the game control unit 44 transmits and receives data regularly or as needed to proceed with the game. For example, the game control unit 44 stores control processing for executing the game in this embodiment, various kinds of necessary data, etc. in the storage unit 46 and provides these items of information to the player terminal 10 as appropriate.

The game control unit 44, on the basis of a command received from the player terminal 10 via the communication unit 43 on the basis of a player input, executes processing associated with that command. Command that will be described include commands for selecting content, selecting game-medium composition information, changing selected-game-medium composition information, changing game-medium composition information, commands for executing each piece of content and events in the content, as well as commands for using recovery items. However, commands may include other commands necessary for proceeding with the game.

The storage units 35 and 46 are configured by using the storage devices 14 and 24. In this embodiment, a first-type game medium group including two or more first-type game media and a second-type game medium group including two or more second-type game media are stored in the storage units 35 and 46. Parameter information of the individual first-type and second-type game media are stored in association with game-medium identification information of the individual game media. The parameter information of each game medium includes an offense level, a defense level, hit points (HP), abilities, etc. Furthermore, in the case where it is possible to raise the level of a game medium, the parameter information also includes information for determining the offence level for each level in the case where the level has been raised. For example, an offense level, a defense level, and HP may be defined for each level, or formulas for calculating values for each level through calculation may be defined.

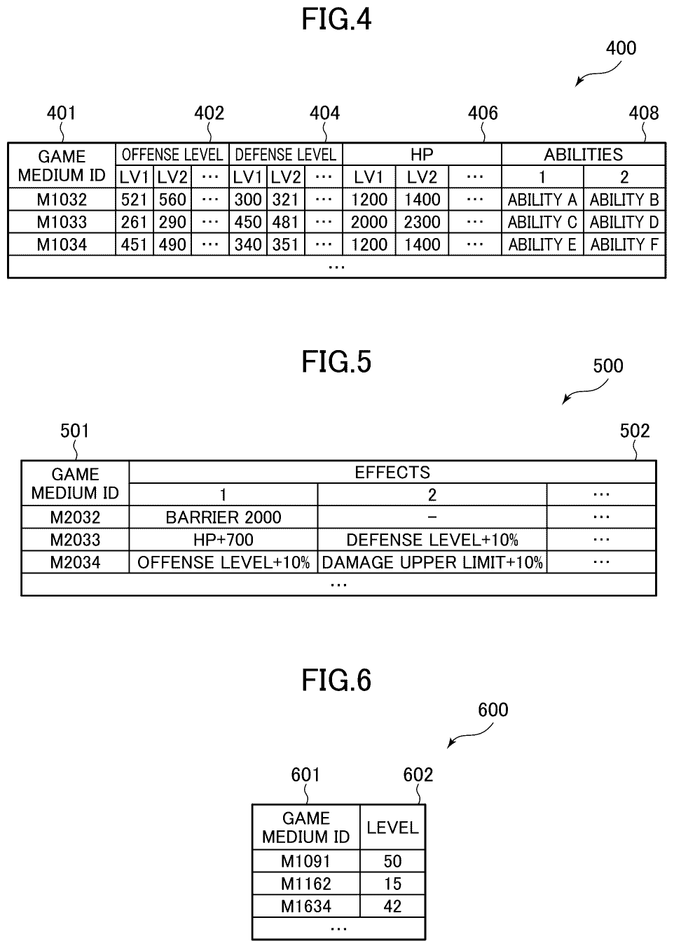

FIG. 4 shows an example table showing information concerning the first-type game medium group including first-type game media, stored in the storage unit 46. Offense levels 402, defense levels 404, and HPs 406 defined for individual levels are stored in association with identification information (IDs) 401 of the first-type game media included in the first-type game medium group. For example, the offense level, the defense level, and the HP in the case where the game medium ID is M1032 and the level is 2 are 560, 321, ad 1400, respectively. Although values of offense level, etc. are predefined for each level here, formula, coefficients, etc. for calculating the offense level, etc. for each level may be defined. The arrangement may be such that the amount of raising is varied depending on a random number. Furthermore, abilities (408) are associated with each game medium ID. Although it is assumed here that two abilities are associated with each game medium ID, other numbers of abilities may be associated, or individual game media may possess different numbers of abilities.

FIG. 5 shows an example table showing information concerning the second-type game medium group including the second-type game media in the storage unit 46. Effects possessed by the individual second-type game media included in the second-type game medium group are defined in association with the game medium IDs (501) of the game media. For example, barrier 2000 is defined as the effect of the game medium ID M2032, HP +700 is defined as effect 1 of M2033, and defense level +10% is defined as effect 2 thereof. The number of effects defined for game media may vary among the game media. Only one effect is defined for M2032, and two effects are defined for ID 2033. Although levels are not set for the second-type game media, levels may be set therefor.

In this embodiment, the first-type game media are characters, and the second-type game media are equipable items. When a character is equipped with a second-type game medium, the effects possessed by the second-type game medium that the character is equipped with are invoked. For example, the effect of barrier 2000 is an effect with which the HP of the character does not decrease until the cumulative damage received from attacks by enemy characters reaches 2000 HP in a battle against the enemy characters. With defense level +10%, the defense level of the character is raised by 10%. Damage upper limit +10% is an effect with which, in the case where an upper limit value is defined for damage given to an enemy character with a single attack in a battle, the upper limit value is raised by 10%.

Furthermore, in the storage unit 46, parameters concerning players, parameters concerning enemy characters, stamina values necessary for executing individual events, battle parameters concerning battles, etc. are stored. In this embodiment, parameters concerning a plurality of players are stored in association with their individual player IDs. The player parameters include player names, player levels, game-medium related information, and stamina related information. These items of information are stored in association with player identification information identifying players.

In this embodiment, a single game includes two types of content. The first-type game media are used in order to play content of the first content type and content of the second content type, and the second-type game media are used to play second-type content. It is assumed that content of both the first content type and of the second content type are played by using a game medium composition arranged to include a plurality of game media.

The game-medium related information includes identification information identifying the first-type game media and second-type game media possessed by a player, as well as parameters such as the levels of the individual game media. Furthermore, the game-medium related information includes first-type composition information indicating a composition including two or more first-type game media selected from among the first-type game media, second-type composition information indicating a composition including two or more second-type game media selected from among the second-type game media, a first-type composition information group including two or more items of first-type composition information, and a second-type composition information group including two or more items of second-type composition information. The game-medium related information further includes selected first-type composition information and laundry-charge second-type composition information.

FIG. 6 shows an example table showing first-type game media associated with a single player ID. Game media IDs indicate the first-type game media possessed by the player identified on the basis of the player ID associated with the table, and levels indicate the levels of the individual game media. It is assumed that the levels of game media can be raised by consuming experience values or items acquired by the player playing the game. The parameters of the individual game media, such as offense levels, can be defined with reference to the levels defined here and the parameters of the first-type game media associated with the corresponding game medium IDs in the table shown in FIG. 4.

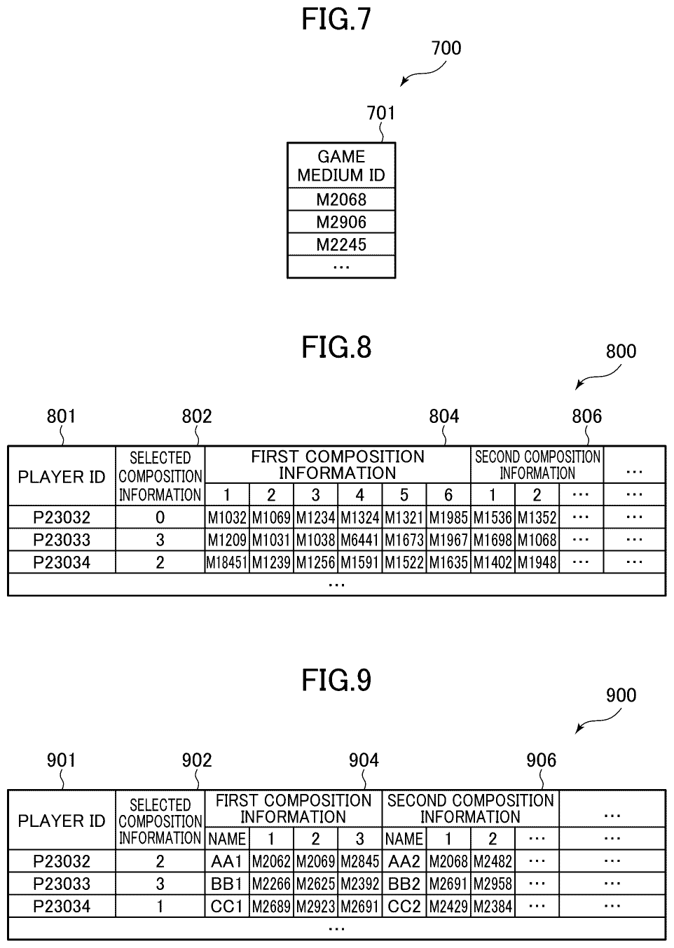

FIG. 7 shows an example table showing second-type game media associated with a single player ID. Game medium IDs indicate the second-type game media possessed by the player identified on the basis of the player ID associated with the table. The effects of the individual game media can be obtained by referring to the parameters of the second-type game media associated with the corresponding game media IDs in the table shown in FIG. 5.

FIG. 8 shows an example table showing selected first-type composition information and first-type composition information groups associated with individual player IDs. Information 802 indicating the selected first-type game composition information and a plurality of items of composition information 804 and 806 are stored in association with each player ID (801). Although only two items of composition information are explicitly shown here, three or more items of composition information can be included. Each item of composition information includes identification information of the first-type game media included in the composition. For example, it is indicated that the first composition information for the player ID P23032 includes M1032, M1069, M1234, M1324, M1321, and M1985 as first-type game media. The game media incorporated in the game-medium composition information are game media possessed by each player, and it is assumed that the game media are set to each item of composition information on the basis of player inputs from the player. However, the game media may be set by a server or the like on the basis of a prescribed rule, without depending on player inputs.

Parameters of each game medium shown in FIG. 8 can be determined by obtaining level information on the basis of the associated player ID with reference to the table showing first-type game media, shown in FIG. 6, and further with reference to the information concerning the first-type game medium group, shown in FIG. 4. The information 802 indicating selected first-type composition information is information indicating selected first-type composition information selected from the first-type composition information group. For example, it is indicated that the first composition information 804 is the selected composition information in the case where the information indicating selected first-type composition information is 0 and that the second composition information 806 is the selected composition information in the case where the information indicating selected first-type composition information is 1.

FIG. 9 shows an example table showing selected second-type composition information and second-type composition information groups associated with individual player IDs. Information indicating selected composition information and a plurality of items of composition information are stored in association with each player ID (901). Although only two items of composition information are shown here, three or more items of composition information can be included. Similarly to FIG. 8, it is assumed that each item of composition information includes identification information of the second-type game media included in the composition, as well as the name of the composition. The name can be set by the player, or the name may be set by a server on the basis of a prescribed rule. The name of composition information is not necessarily required. The name of each composition may also be included in first-type composition information. The game media included in composition information are the game media possessed by each player, shown in FIG. 7. The effects of individual game media, shown in FIG. 9, can be determined on the basis of the information concerning the second-type game medium group, shown in FIG. 5.

This embodiment is arranged such that the game includes two types of content, of which content of the first content type is executed on the basis of the consumption of a first parameter, whereas content of the second content type is executed on the basis of the consumption of a second parameter. However, the types of content do not matter as long as different types of content are included. It is assumed here that the first parameter and the second parameter are a first stamina value and a second stamina value.

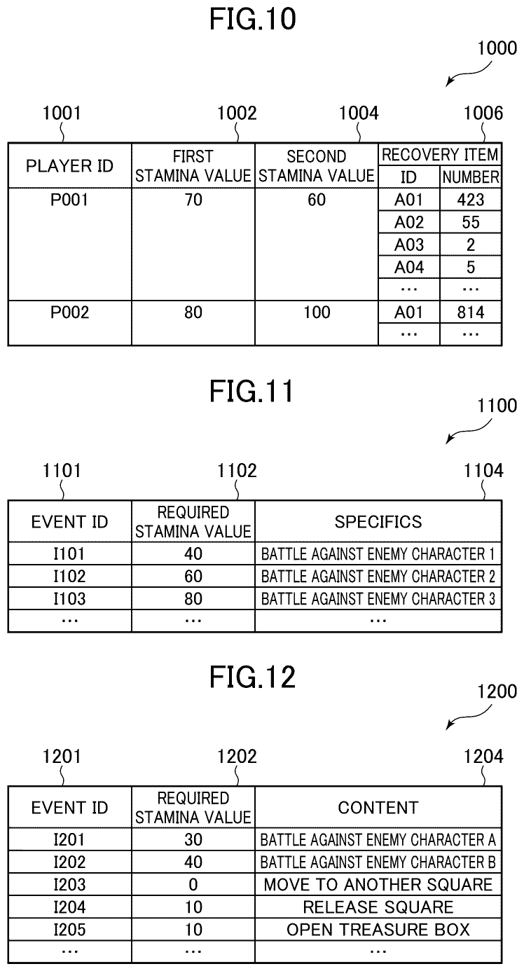

The stamina-related information of a player includes a first stamina value, a second stamina value, information concerning recovery items possessed for recovering stamina, etc. associated with the player ID. The information concerning recovery items includes item identification information identifying recovery items and information indicating the number possessed. FIG. 10 shows an example table showing stamina related information.

A first stamina value, a second stamina value, and information concerning possessed items are stored in association with the player ID. The first and second stamina values are reduced or recovered as needed by the stamina management unit 45, which will be described later. The information concerning recovery items includes recovery item IDs and number information. Recovery item IDs are identifiers identifying items serving as game media, and the number indicates the number thereof possessed by the player. While being game media, recovery items, which are items that are consumed in order to recover stamina, differ from the first-type and second-type game media.

It is assumed that there are two types of recovery items, namely, a recovery item A and a recovery item B, and that the recovery item A is identified with an item identifier A01 and the recovery item B is identified with an item identifier A02. Both are commonly a recovery item that can be used to recover the first and second stamina values, but the amounts of recovering the individual stamina values vary. Here, recovery refers to increasing the stamina values. Recovery items are consumed upon being used, and the number possessed is decreased by the number consumed. For example, a recovery item can be acquired as a victory reward in the case where a battle against an enemy character has been won, can be obtained by purchasing it through payment, or can be obtained as an item that is obtained as a result of executing a treasure box opening event as content of the second content type, which will be described later. The arrangement may be such that a recovery item can be obtained through other means.

Player parameters may further include information such as a player level and possessed items. Parameters of each enemy character include, for example, the ID, name, level, offense level, defense level, hit points, etc. of the enemy character. Battle parameters include the parameters of the player and the parameter of the enemy characters participating in a battle. Each parameter may change as the battle proceeds. For example, the hit points decrease as a result of an attack by an enemy, and the offense level and defense level can be raised and lowered with special abilities. Furthermore, a battle may be a multi-battle, in which a plurality of players cooperatively play a battle against a common enemy character. In the case of a multi-battle, the parameters of the plurality of participating players are stored in association with identification information identifying the single battle.

In this embodiment, content of the first and second content types includes a plurality of events, and content is executed by executing events, whereby the game proceeds. The execution of an event can be considered as the execution of content, or an event can be considered as a form of content. Events include battles played against enemy characters. The arrangement may be such that content itself is executed, instead of including events in content. FIGS. 11 and 12 show example tables showing stamina values necessary for executing individual events. The table shown in FIG. 11 shows stamina values necessary for executing individual events in content of the first type, and the table shown in FIG. 12 shows stamina values necessary for executing individual events in content of the second type. Although these tables are stored in the storage unit 46 in this embodiment, these tables may be stored as a single table, may be stored in the storage unit 35, or may be stored in both of the storage units 35 and 46.

The event IDs are identification information for identifying individual events, and the necessary stamina values are stamina values necessary for executing the associated events. The specifics include information indicating the specifics of each event. In the case where the corresponding stamina value of the player is less than the necessary stamina value, it is not possible to execute the event.

The stamina management unit 45, upon accepting a content execution command for executing an event of the first content type on the basis of a user input from a player, decreases the first stamina value stored in the storage unit 46 in association with the player ID of the player, and upon accepting a content execution command for executing an event of the second content type, decreases the second stamina value stored in the storage unit 46 in association with the player ID of the player. In decreasing a stamina value, the stamina management unit 45 reads out the corresponding stamina value necessary for executing the event from FIG. 11 or 12 and subtracts the stamina value from the first or second stamina value in the storage unit 46 to update the first or second stamina value.

Furthermore, the stamina management unit 45 recovers the first stamina value according to a first condition and recovers the second stamina value according to a second condition. Furthermore, the stamina management unit 45 recovers the first stamina value upon accepting a recovery-item use command for using, for the first stamina value, a recovery item that can commonly be used for recovering the first and second stamina values. Furthermore, the stamina management unit 45 recovers the second stamina value upon accepting a recovery-item use command for using the recovery item for the second stamina value.

Each item of content and each event are played by using game media based on game-medium composition information stored in the storage unit 46. The first-type game media are used to play content of the first content type and content of the second content type, and the second-type game media are used to play content of the second content type. Therefore, the first-type composition information is used to play first-type content and second-type content, and the second-type composition information is used to play content of the second content type. It is assumed here that game media based on composition information are used when executing events of battles against enemy characters among events of the first-type and second-type content.

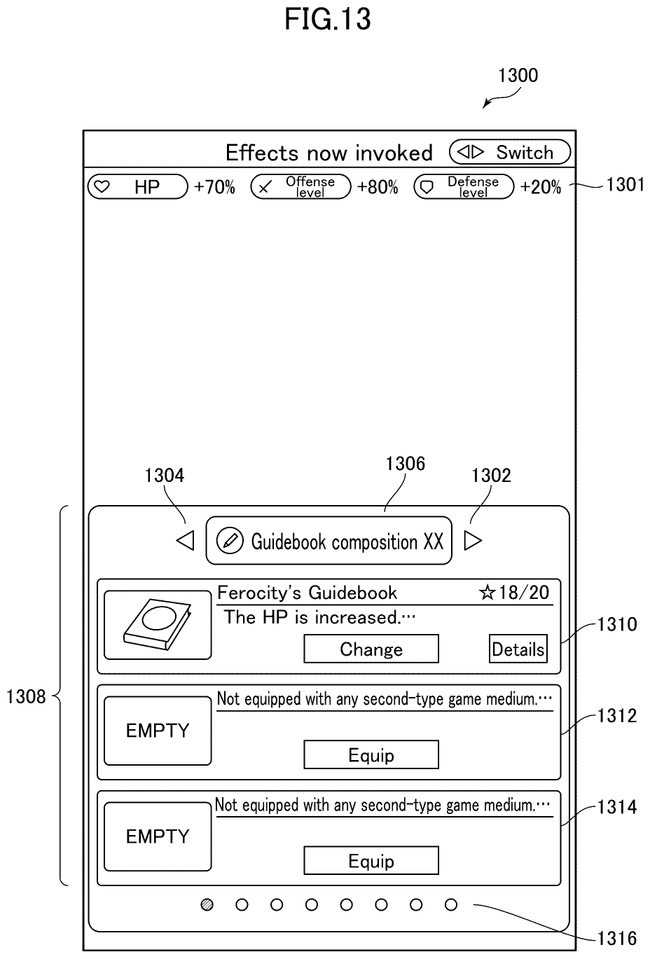

The game control unit 44 can create composition information of game media. FIG. 13 shows an example screen for creating second-type composition information on the basis of player inputs. It is assumed here that the second-type composition information group can include eight items of second-type composition information, the individual items of second-type composition information being individually associated with eight composition-information corresponding parts (circular marks) indicated in a second-type composition-information specification section 1316. When one of the composition-information corresponding parts has been specified on the basis of a player input, the second-type composition information corresponding to the specified composition-information corresponding part is displayed in a second-type composition-information setting section 1308.

By performing player inputs to second-type composition-information switching parts 1302 and 1304, it is possible to sequentially switch the second-type composition information displayed as the composition being created to other second-type composition information in the second-type composition information group. For example, it is possible to assign values indicating an order of display to the second-type composition information included in the second-type composition information group and to switch display according to this order of display. The arrangement may be such that when the second-type composition-information switching part 1302 indicating the right direction is touched in a state where a first item of second-type composition information is displayed, a second item of second-type composition information is displayed in the second-type composition-information setting section 1308, and may be such that when the second-type composition-information switching part 1304 indicating the left direction is then touched, a second item of second-type composition information is displayed.

Here, it is possible to set three second-type game media at most in a single item of second-type composition information. The second-type composition-information setting section 1308 includes three game-medium setting sections 1310, 1312, and 1314. In the game-medium setting section 1310, a game medium is already set, and thus it is possible to accept a player input for changing the game medium. In the game-medium setting sections 1312 and 1314, since no game medium is set, it is possible to accept player inputs for newly setting game media.

When a player input to each game-medium setting section is performed, it is possible to accept the specification of a game medium to be set from among the second-type game media possessed by the player. When a game medium to be set has been specified on the basis of the player input, the game medium is set in the second-type composition information and is displayed in the game-medium setting section.

In a second-type composition-information name display section 1306, the name of the displayed second-type composition information is displayed. In an effects-now-invoked display section 1301, effects that are invoked in the case where the displayed second-type composition information is used are shown.

The game control unit 44 displays a composition image showing a first composition area for displaying selected first-type composition information selected from the first-type composition information group for use in content and also showing a second composition area for displaying selected second-type composition information selected from the second-type composition information group. The game control unit 44 changes the selected first-type composition information on the basis of player inputs corresponding to the first composition area and changes the selected second-type composition information on the basis of player inputs corresponding to the second composition area. The game control unit 44 can execute content on the basis of the selected first-type composition information and the selected second-type composition information.

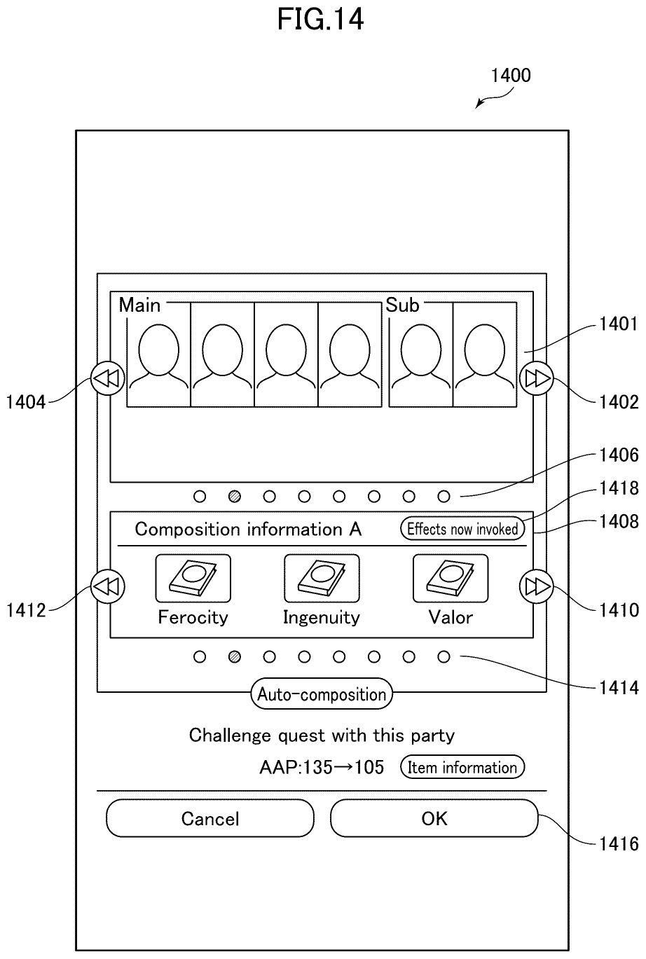

FIG. 14 shows an example game screen for setting selected composition information for use in content. Although it is assumed here that a game screen 1400 is displayed after the player selects an event in second-type content that the player is starting to play, in order to determine a composition for use in the event, the game screen 1400 may be displayed irrespectively of the start of the play. In this case, preferably, whether the type of content for which composition information is to be used is content of the first type or content of the second type should be identified.

The game screen 1400 is a screen for displaying a composition image including a first composition area 1401 and a second composition area 1408. The first composition area displays selected first-type composition information selected from the first-type composition information group for use in an event serving as content to be played. It is assumed that, for example, the first composition information in FIG. 8 is selected in the initial state as the selected first-type composition information that has been selected, which can then be changed according to player inputs.

It is assumed here that the first-type composition information group can include six items of first-type composition information, the individual items of first-type composition information being individually associated with six composition-information corresponding parts (circular marks) indicated in a first-type composition-information specification section 1406. When one of the composition-information corresponding parts has been specified on the basis of a player input, the first-type composition information corresponding to the specified composition-information corresponding part is selected as new selected first composition information, is changed, and is displayed in the first composition area 1401.

By performing player inputs to first-type composition-information switching parts 1402 and 1404, it is possible to sequentially switch the selected first-type composition information to other first-type composition information in the first-type composition information group. For example, it is possible to assign values indicating an order of display to the first-type composition information included in the first-type composition information group and to switch display according to this order of display. The arrangement may be such that when the first-type composition-information switching part 1402 indicating the right direction is touched in a state where a first item of first-type composition information is displayed, a second item of first-type composition information is changed to the selected first-type composition information and is displayed, and may be such that when the first-type composition-information switching part 1404 indicating the left direction is then touched, the second item of first-type composition information is selected and displayed.

The second composition area 1408 displays selected second-type composition information selected from the second-type composition information group for use in an event serving as content to be played. For example, the first composition information in FIG. 9 is set in the initial state as the selected second-type composition information that has been selected, which can then be changed according to player inputs.

It is assumed that the second-type composition information group can include eight items of second-type composition information. Similarly to the first-type composition information, individual items of second-type composition information are individually associated with the eight composition-information corresponding parts (circular marks) indicated in the second-type composition-information specification section 1414. When one of the composition-information corresponding parts has been specified on the basis of a player input, the second-type composition information corresponding to the specified composition-information corresponding part is selected, is changed to the selected second composition information, and is displayed in the second composition area 1408. By performing player inputs to second-type composition-information switching parts 1410 and 1412, similarly to the first-type composition information, it is possible to sequentially switch the selected second-type composition information to other second-type composition information in the second-type composition information group.

Here, displaying selected first composition information and selected second composition information includes displaying information such as images or game medium names indicating the game media included in composition information on the basis of the selected first composition information and the selected second composition information. The screen 1400 in FIG. 14 shows an example in which images indicating the game media included in the individual items of selected composition information are displayed.

It is assumed that, in this embodiment, a composition image including a first composition area and a second composition area is displayed within a single screen and player inputs corresponding to the first composition area and player inputs corresponding to the second composition area include the same kinds of operational inputs. The arrangement may be such that one or more same kinds of operations are included and one or more kinds of different operations are included. The kinds of operational inputs may include horizontal flick operations and swipe operations in the individual composition areas in addition to the input operations to prescribed player input parts and input operations to corresponding parts in the composition information corresponding parts, described above. Furthermore, the kinds of operational inputs may include input operations to directional instruction input buttons or the like of a physical button.

With this configuration, it is possible to select first-type and second-type composition information for use in content within a single screen, and it is possible to select first-type and second-type composition information with the same kind of operational input. This reduces the number of operations and the number of screen transitions required for the player in starting to play content, and enables intuitive operations.

The composition image is generated on the basis of the content to be executed, selected by the player. In the case where the content to be executed is second-type content, selected first composition information is displayed in the first composition area, and selected second composition information is displayed in the second composition area. The arrangement may be such that, in the case where the content to be executed is first-type content, in the second composition area, instead of the selected second-type composition information, other selected first-type composition information selected from the first-type composition information group or a first-type game medium selected from among a plurality of first-type game media associated with the player ID of the player (possessed by the player) is displayed.

The other selected first-type composition information displayed in the second area may be first-type composition information associated with the player ID of another player different from the player performing operational inputs to the game screen for setting selected composition information, or may be a single first-type game medium. The arrangement may be such that the player is allowed to select the first-type composition information or first-type game medium of another player from among the first-type composition information or first-type game media of a plurality of other players. The arrangement may be such that it is possible to play content without having to use first-type composition information or a first-type game medium of another player.

While it is not possible to use second-type game media in first-type content, in the case where it is possible to set two items of first-type composition information or in the case where it is possible to set an additional first-type game medium, similarly to the case of determining a composition of game media for second-type content, it becomes possible to simultaneously set two items of first-type composition information or first-type game media within a single screen. The arrangement may be such that the second composition area is not displayed for content with which it is not possible to use two items of first-type composition information.

The arrangement may be such that it is possible to edit selected composition information by performing operational inputs, such as tap inputs, to the inside of each of the first composition area 1401 and the second composition area 1408 in the game screen 1400. For example, when the second composition area 1408 is tapped, it is possible to transfer to the screen for editing second composition information, shown in FIG. 13.

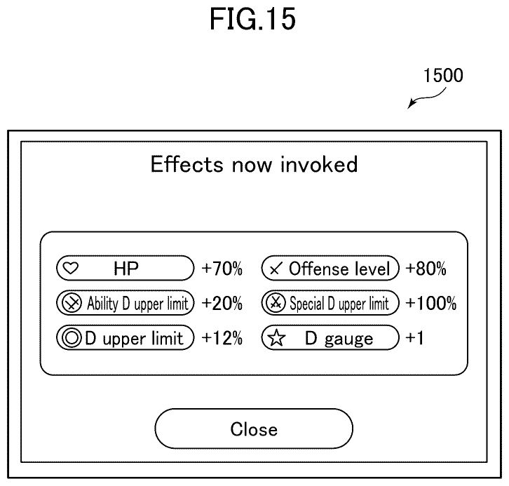

When a player input to an effects-now-invoked information instruction section 1418 has been performed, it is possible to display a screen displaying the effects now invoked by the second-type game media in the composition based on the selected second-type composition information (FIG. 15). When a player input to a composition-information fixing input section 1416 has been performed, the composition information displayed in the first and second composition areas is determined as selected composition information for playing content, which makes it possible to start the execution of the content specified by the player.

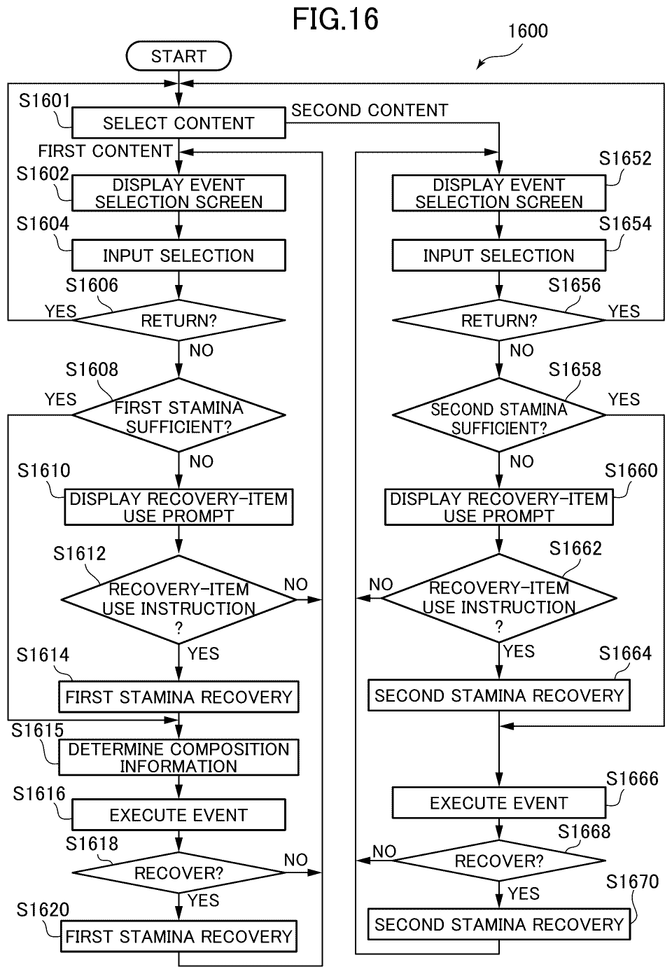

Next, information processing executed at the game system 1 according to an embodiment of the present invention will be described with reference to a flowchart shown in FIG. 16. The game system in this embodiment includes content of the first content type and the second content type, and players can play both types of content. The content of both the first and second content types includes a plurality of events with which stamina is consumed for execution. First stamina is consumed for content of the first content type, and second stamina is consumed for content of the second content type.

It is assumed here that content of the first content type refers to a group of events that are executed by consuming the first stamina value, and content of the second content type refers to a group of events that are executed by consuming the second stamina value. The arrangement may be such that instead of including a plurality of events in content of the first and second content types, the first or second stamina value may be consumed for the execution of each item of content. In this case, each item of content may be an event or may include an event. Furthermore, stamina refers to points necessary for executing the corresponding content or event, and can be referred to as execution points or action points.

In this embodiment, a stamina recovery process is executed according to a prescribed condition as a process that is executed in parallel with the process that is executed according to the flowchart shown in FIG. 16. Here, the stamina management unit 45 recovers the first stamina value according to a first condition and recovers the second stamina value according to a second condition. The first condition and second condition may be different conditions. The first and second conditions are both based on time. In the recovery of the first stamina value according to the first condition, the first stamina value is recovered by a first amount according to the time elapsed. In the recovery of the second stamina value according to the second condition, the second stamina value is recovered by a second amount when a prescribed time arrives.

For example, the first stamina value is recovered by 1 per five minutes, and the second stamina value is recovered by 100 when five AM arrives. The second stamina value is recovered by 100 when the second stamina value is less than 100 at the timing of five AM, but is not recovered when the second stamina value is greater than or equal to 100. Note that, as a modification, the second stamina value may be recovered to an upper limit value of 100 when five AM arrives. The upper limit value of the first stamina value is set to 150, which limits the recovery of the first stamina value based on the time elapsed to within the upper limit value, and the first stamina value is not increased further after the upper limit value is reached even if time elapses. Furthermore, the upper limit values of the first stamina value and the second stamina value may be raised in accordance with the level of the player.

As a modification, the first stamina value and the second stamina value may be recovered at the same recovery cycle, or may be recovered at the same time. While adopting the same recovery cycle or recovery time, it is possible to vary the amounts of recovery or to set different upper-limit values of time-based recovery. Furthermore, the stamina values may be recovered on condition that a user input for pressing a recovery button has been performed in a game screen displayed on the player terminal 10 or a prescribed quest has been cleared after the elapse of a certain time or the arrival of a prescribed time.

It is assumed that, in content of the first content type, without limitation to recovery based on the elapse of time, the first stamina value can also be recovered when the level of the player has been raised, when a message has been posted to an SNS on the basis of a command based on an operation of the player terminal 10 by the player, when a recovery item described later has been used, and when a battle has been terminated in the middle instead of being finished. It is assumed that, in content of the second content type, as well as the case where a prescribed time has arrived, the second stamina value can also be recovered when a recovery item described later has been used, when a battle has been terminated in the middle, and after the end of a battle against a treasure box enemy character.

The flowchart shown in FIG. 16 indicates information processing executed between the server 20 and one player terminal 10, and the same processing may be executed concurrently and separately with the player terminals 10 of all the players. The processing that is executed concurrently can be executed, for example, in association with the individual player IDs.

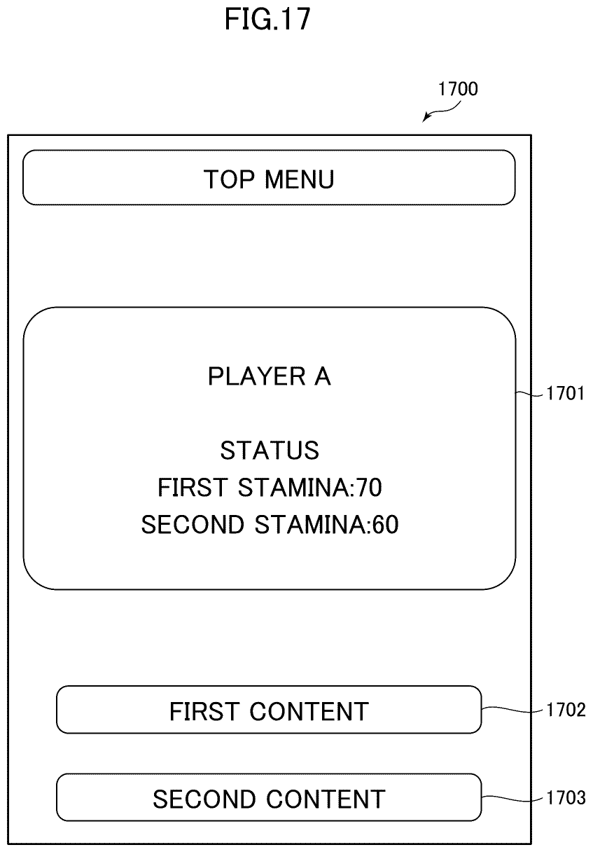

First, the player performs a user input for selecting content at the player terminal 10 to transmit content selection information indicating the selected content to the server 20 (S1601). FIG. 17 shows an example game screen for selecting content. When the server 20 is accessed by using a browser program at the player terminal 10, a content selection screen 1700 is displayed as an initial screen. In a status display area 1701, a player name (player A) as well as the current values of the first and second stamina values are displayed. When a selection area 1702 for selecting first content, which is content of the first content type, is touched, a user input for selecting first content is performed. When a selection area 1703 for selecting second content, which is content of the second content type, is touched, a user input for selecting second content is performed. Furthermore, third and further items of content, which are content of the first or second type, may be included.

Upon receiving selection information for selecting first content, the server 20 causes the display unit 32 of the player terminal 10 to display an event selection screen (S1602). When an event has been selected by the player, the player terminal 10 transmits a command for instructing the execution of the event to the server 20 (S1604). In the case where the player has performed a user input for returning to content selection (S1606), the process returns to content selection (S1601).

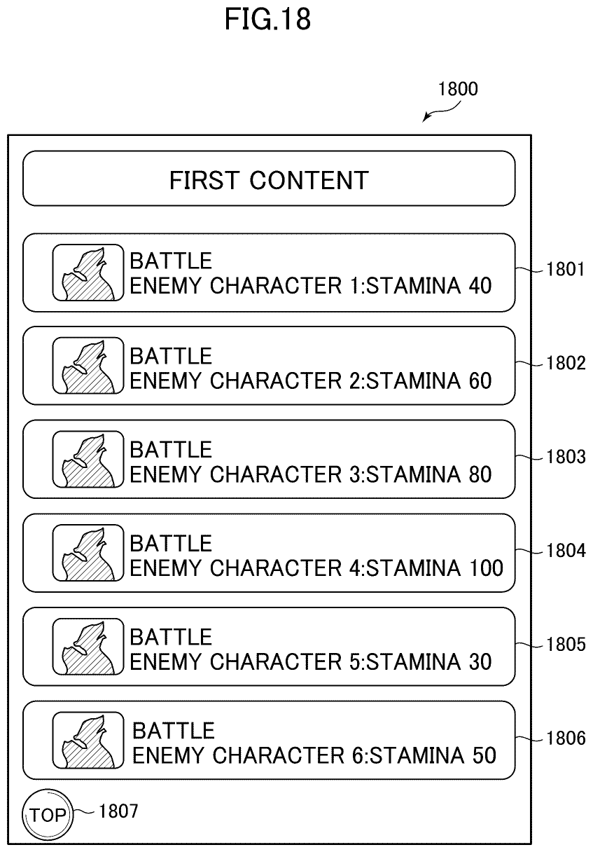

FIG. 18 shows an example event selection screen for first content in this embodiment. Although it is assumed here that events in first content are only battles, as a modification, other events may be included. An event selection screen 1800 includes battle selection areas 1801 to 1806 for selecting a battle as an event. Each of the battle selection areas indicates the name of the enemy character in the battle and the stamina value required for execution. The player performs a user input for selecting one of these battle selection areas at the player terminal 10 and transmits a command for executing the selected event to the server 20 (S1604). The event selection screen 1800 also includes a selection area 1807 for returning to the content selection screen 1700. When a user input for selecting the selection area 1807 has been performed, the process returns to the content selection screen 1700 (S1601).

Upon receiving the event execution command, the server 20 determines whether or not the current first stamina value of the relevant player is greater than or equal to the stamina value necessary for executing the selected event (S1608). In the case where it is determined that the current first stamina value of the relevant player is not greater than or equal to the stamina value necessary for executing the selected event, a prompt for a recovery-item use instruction is displayed at the player terminal 10 (S1610). When a user input for instructing the use of a recovery item for the first stamina is performed by the player at the player terminal 10 and the server 20 accepts a recovery-item use command transmitted on the basis of the user input (S1612), the first stamina value is recovered (S1614). When a user input indicating no use of the recovery item is performed by the player, the process returns to the displaying of the event selection screen (S1602).

In this embodiment, it is assumed that there are two kinds of recovery items, namely, a recovery item A and a recovery item B, and that the amounts of stamina value recovered vary when the respective recovery items are used. For example, it is assumed that the first stamina value is recovered by 150 in the case where the recovery item A is used and that the first stamina value is recovered by 75 when the recovery item B is used. In this embodiment, recovering a stamina value refers to increasing the stamina value. For example, in the case where the current first stamina value is 50, when the recovery item A is used, 150 is added to the first stamina value, whereby the first stamina value is increased to 200, whereas in the case where the recovery item B is used, 75 is added to the first stamina value, whereby the first stamina value is increased to 125. Furthermore, in the case where an upper limit value is defined for the first stamina value, the first stamina value may be increased within the upper limit value or may be increased beyond the upper limit value.

When using a recovery item, the player performs a user input for specifying the kind of recovery item to use and the stamina value to use. The arrangement may be such that, in the screen for prompting the use of a recovery item in S1610, the first stamina value is set as the stamina value to use and information for allowing selection of one of the recovery items A and B is displayed, omitting selection of the stamina value to use by the player.

When the first stamina value of the player is greater than or equal to the stamina value necessary for the event specified by the player or has become greater than or equal to the stamina value necessary for the event as a result of recovery with a recovery item, the specified event is executed by consuming the first stamina value of the player (S1616).

It is assumed that, in this embodiment, prior to event execution processing, processing for determining composition information used in the event to be executed is executed (S1615). Details will be described later in relation to event execution in second content.

In S1618, it is determined whether or not to recover the first stamina value as a result of satisfaction of a prescribed condition. In the case where it is determined to recover the first stamina value, the first stamina value is recovered in S1620, and the process returns to displaying of the event selection screen (S1602) for the execution of the next event. In the case where it is determined not to recover the first stamina value in S1618, without recovering the first stamina value, the process returns to displaying of the event selection screen (S1602) for selecting the next event to be executed.

In this embodiment, there are cases where stamina is recovered after the end of the execution of an event. For example, while a battle against an enemy character is finished when the battle is won by making the hit points of the enemy character zero through attacks by the player character, it is possible to interrupt and terminate a battle, without winning the battle, by the player performing a user input for withdrawal before the hit points of the enemy character become zero. In this case, in prescribed battles, the stamina management unit 45 may recover the entire or partial first stamina value consumed for the execution of the battles. Here, whether or not to recover stamina is determined (S1618) on condition of the termination of a battle due to an interruption resulting from a user input in a battle against a predetermined enemy character.

Next, processing (S1652 to S1670) in the case where second content is selected in content selection (S1601) will be described. Since the processing in the case where second content is selected is similar to the processing in the case where first content is selected, repeated descriptions will be omitted.

When second content has been selected, the event selection screen is displayed (S1652). When the player has performed a user input for selecting an event (S1654), it is determined whether or not the second stamina value of the player is sufficient for executing the selected event (S1658). In the case where the player has selected an operational input for returning to the content selection screen, the process returns to the content selection processing (S1601).

If the second stamina value is sufficient for executing the selected event, the selected event is executed by consuming an amount of the second stamina value corresponding to the stamina value necessary for the event. In the case where the second stamina value is insufficient, a prompt for using a recovery item is displayed (S1660). When a recovery-item use instruction is input by the player, the second stamina value is recovered (S1664). If a recovery-item use instruction is not input, the process returns to displaying of the event selection screen (S1652).

It is assumed that, in this embodiment, the amount of recovery of the second stamina value with a recovery item differs from the amount of recovery of the first stamina value when the same recovery item is used. For example, in the case where the recovery items A and B are used for recovering the first stamina value, the amounts of recovery of the first stamina value are 150 and 75; and in the case where the recovery items A and B are used for recovering the second stamina value, the amounts of recovery of the second stamina value are 100 and 50. The arrangement may be such that the second stamina value can be recovered beyond an upper limit value, similarly to the first stamina value.

After an event is executed, whether or not to recover the second stamina value is determined (S1668). When it is determined to recover the second stamina value, the second stamina value is recovered (S1670). When it is determined not to recover the second stamina value, without recovering the second stamina value, the process returns to displaying of the event selection screen (S1652).

In this embodiment, after the end of the execution of an event, for example, upon withdrawal from a battle against an enemy character in an unreleased square, which will be described later, or upon completion of a battle against a treasure box enemy character, the stamina management unit 45, in prescribed battles, recovers the entire or partial first stamina value consumed for the execution of the battles. For example, in the case where a battle has been finished by defeating a treasure box enemy character, the first stamina value is recovered by 20. It is also possible for individually set the amount of stamina value to be recovered for each treasure box enemy character.

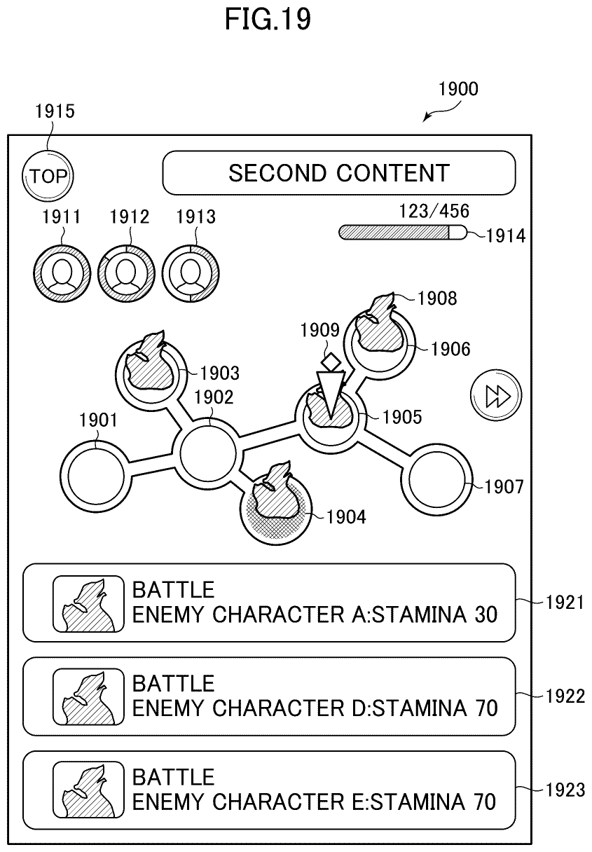

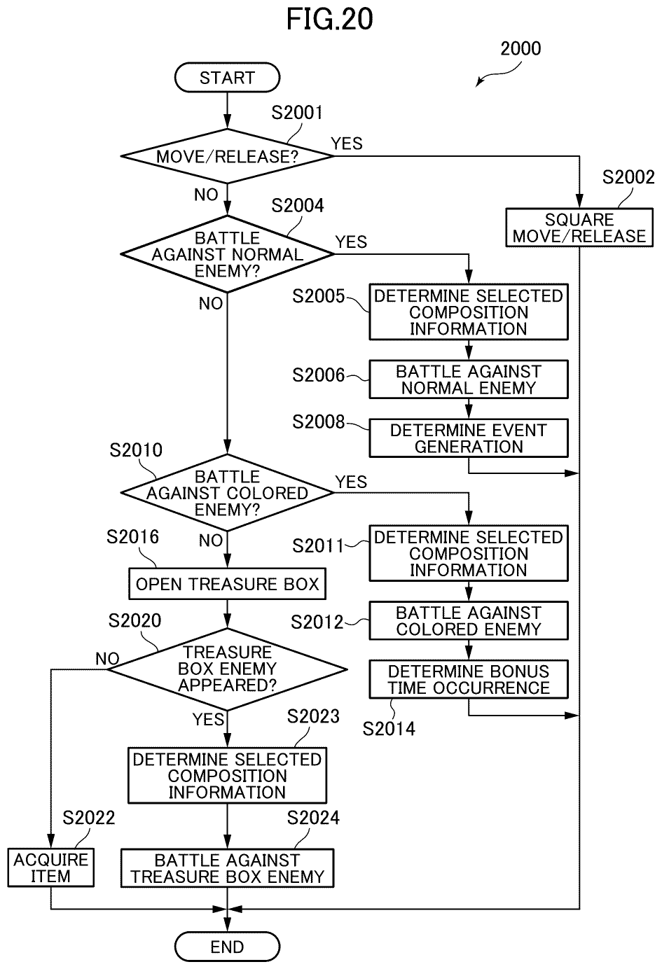

An example in the case where second content is selected in this embodiment will be described with reference to FIGS. 19 and 20. It is assumed that second content includes battles and also includes events other than battles. Here, the events other than battles include movement between squares and release of squares in a map and opening of treasure boxes. In content (events) of the second content type, a map including a plurality of squares 1901 to 1907, shown in FIG. 19, is used, and the game proceeds while the players move through the squares in the map. A position indication 1909 indicates the current position of the player, and it is indicated that the player is disposed at the square 1905 in FIG. 19.

An image 1908 indicates that an enemy character is disposed at the square 1906. Similarly, the images shown on the squares 1903 to 1905 indicate that enemy characters are disposed at the individual squares. The arrangement may be such that whether an enemy character disposed is an ordinary enemy character or a colored enemy character, which will be described later, is indicated by an image showing the enemy character. The player can perform a user input for executing a movement event by selecting the region where a square to which the player wishes to move is displayed. By selecting a selection area 1915, it is possible to return to a menu for selecting first and second content, shown in FIG. 17.

Each square can take one of two states, namely, released and unreleased. The game is started in a state where at least some of the squares are unreleased. When the player selects an unreleased square, a release event is executed, whereby the state of the square changes to an open state. Here, it is assumed that the release event involves a movement. A movement event and a release event may be executed as separate events. In order to execute a square release event, the second stamina of the player is consumed. The second stamina is not consumed for movement to a released square. In FIG. 19, in unreleased squares, unreleased indications indicating that the squares are in unreleased states are displayed, as in the square 1904, so that the player can recognize the unreleased squares.

The game control unit 44 disposes enemy characters in squares. The enemy characters disposed, as well as the squares, can be determined at random on the basis of random numbers, can be determined in advance by a game system administrator or the like, or can be disposed by combining these methods. Having moved to a square in which an enemy character is disposed, the player can execute a battle against the enemy character disposed in the square. For example, in FIG. 19, the player moves to the square 1905, and the player can execute a battle against enemy characters A, D, and E disposed in the square 1905. The player can transmit a command for executing a selected battle to the server 20 by performing a user input to select one of event-to-execute selection areas 1921, 1922, and 1923 at the player terminal 10.

In this embodiment, at least some of the enemy characters are kept disposed in the squares without being erased even after being defeated in battles, so that battles can be played again with the same enemy characters. Furthermore, the parameters of the enemy characters are varied on the basis of the number of battles. Preferably, the parameters are changed so that the enemy characters become stronger as the number of battles increases. For example, the parameters of the offense level and defense level of the enemy characters are raised by 10% each time the number of battles increases. The raised parameters of the enemy characters may be calculated as needed by using prescribed coefficients or may be determined on the basis of a preset table. More preferably, the parameters of the enemy characters are raised until a prescribed number of times, such as ten challenges, and are not changed thereafter. The number of challenges is reset at a prescribed time once a day, thereby restoring the parameters of the enemy characters to initial values or restoring values that have been raised through the prescribed number of challenges.

In the case where the parameters of the enemy characters are fixed values, the difficulty of each battle as perceived by the player considerably varies depending on the level of the player. For example, if the parameters of the enemy characters are set high, the enemy characters are too strong for low-level players to defeat, which might compromise the motivation for playing. Meanwhile, if the parameters of the enemy characters are set low, the enemy characters are too weak for high-level players, which is boring and compromises the motivation for playing. By setting the initial parameters of the enemy characters low and letting each player repeatedly play battles against the enemy characters as many times as possible depending on the level of the player, it becomes possible to enjoy battles with parameters suitable for the level of each player. Furthermore, when the level of a player is raised through game plays, it becomes possible for the player to perform a greater number of challenges than before, which makes it possible for the player to realize a sense of his or her own growth, serving to enhance motivation for continuous playing.

As further game media separate from first-type and second-type game media, or as one of these types of game media, the player may be allowed to create a weapon composition including a prescribed number of weapon items and to use the weapon composition in battles against enemy characters. The player can possess a plurality of weapon items. The player creates a weapon composition by specifying a prescribed number of weapon items from the plurality of weapon items, and the weapon composition created is stored as weapon composition information in association with the player. The weapon composition information can include a plurality of weapon compositions. When starting a battle, the player determines a weapon composition for use in the battle. The offense level parameter of the player is determined on the basis of the weapon composition used in the battle. It is assumed that ten weapon items at most can be included in a single weapon composition in first content and that thirteen items at most can be included in a single weapon composition in second content. By making it possible to include a greater number of weapon items in second content than in first content, the flexibility of composition is increased, which makes it possible to provide a greater fun of considering composition strategies.

The game control unit 44 can also dispose treasure boxes in squares. A plurality of kinds of treasure boxes are prepared, and items that can be acquired vary depending on the kinds of treasure boxes. Furthermore, the probabilities of occurrence of items that are acquired may be varied depending on the kinds of treasure boxes. For example, super-rare treasure boxes, rare treasure boxes, and normal treasure boxes are used, rare items can be acquired from only super-rare treasure boxes and rare treasure boxes, and it is possible to set the probabilities of occurrence of rare items such that the probabilities are higher with super-rare treasure boxes. Whether or not a rare item occurs in a treasure-box opening event can be determined through lottery processing by using a random number on the basis of the set probabilities. The treasure boxes that are disposed, as well as squares, can be determined at random on the basis of random numbers or can be determined in advance by a game system administrator or the like. Having moved to a square in which an enemy character is disposed, the player can open a treasure box disposed in the square.

It is assumed that, in this embodiment, treasure boxes whose probabilities of occurrence change when battle events are executed are further used. Here, the treasure boxes are colored gauge treasure boxes, including yellow gauge treasure boxes, green gauge treasure boxes, and red gauge treasure boxes. As player parameters, colored gauge values, namely, a yellow gauge value, a green gauge value, and a red gauge value, are stored in association with each player, and the probabilities of occurrence of the colored gauge treasure boxes change on the basis of the individual corresponding gauge values. In the game screen 1900 shown in FIG. 19, icons 1911 to 1913 indicate the current yellow gauge value, green gauge value, and red gauge value, respectively. For example, it becomes possible to raise the probability of occurrence of the corresponding colored gauge treasure box as each gauge value becomes greater.

Each gauge value can be increased by executing battles and defeating enemy characters. As the enemy characters, in addition to normal enemy characters, colored enemy characters, namely, yellow enemy characters, green enemy characters, and red enemy characters, appear. When a normal enemy character has been defeated, one of the colored gauge values, determined through lottery processing, is increased. In the case where a colored enemy character has been defeated, the corresponding colored gauge value is increased. Preferably, the amount of increase of a colored gauge in the case where a colored enemy character has been defeated is greater than that in the case where an ordinary enemy character has been defeated. The amount of increase in a gauge value may be a predetermined constant value, may be determined through lottery processing, and can be determined by using various methods, such as using values predetermined for individual enemy characters.

For example, the occurrence of a colored gauge treasure box is determined at a probability based on the colored gauge value of the corresponding color in generated-event lottery processing executed after an enemy character is defeated. The corresponding colored treasure box occurs with a probability of 100% if the colored gauge value is 100, and the corresponding colored treasure box occurs with a probability of 10% if the colored gauge value is 10. The colored gauge value is allowed to take a numerical value exceeding 100, and the probability of occurrence is 100% in the case where the colored gauge value exceeds 100. When a normal enemy character has been defeated, one of the gauges, determined through a lottery, is increased by 10. When a colored enemy character has been defeated, the gauge value of the corresponding color is increased by 20, and in the case where a colored gauge treasure box has occurred, the colored gauge value at that timing is decreased to half. Furthermore, preferably, the colored gauge values are reset at a prescribed time. This makes it possible to enhance the motivation for playing the game so as to acquire colored treasure boxes before the resetting.

It is possible to set a bonus time, in which the amount of gauge increase is increased. For example, after a colored enemy character is defeated, whether or not to generate a bonus time is determined through lottery processing on the basis of a prescribed probability, and the amount of gauge increase is increased during a prescribed period after it is determined to generate a bonus time. It is possible to efficiently increase the colored gauges by defeating enemy characters during this bonus period, which makes it possible to enhance the player's motivation for playing.

In second content, as described earlier, events such as movement between squares, square release, opening treasure boxes, and battles are executed. As shown in FIG. 12, each event has defined therefor a stamina value necessary for execution, and the second stamina value is decreased as a result of executing the event on the basis of a user input from the player. It is assumed that the second stamina value is not consumed in the case of only movement not involving release of a square. A stamina gauge 1914 in FIG. 19 indicates the current second stamina value.

An example specific process of the event execution processing (S1666) in FIG. 16 will be described with reference to FIG. 20. The processing that is executed varies on the basis of the event selection input performed by the player in S1654. First, it is determined whether the event to be executed is a movement between squares or a square release (S2001). It is assumed here that a release event involves a movement. A movement event is executed in the case where the event is a movement between squares or a square release. In the case of a square release, square release and movement events are executed, and the second stamina value is decreased by a stamina value of 10, which is necessary for a square release (S2002).

In the case where the event to be executed is neither a movement nor a release, it is determined whether or not the event is a battle against a normal enemy character (S2004). In the case of a battle against a normal enemy character, processing for determining composition information for use in the battle is executed (S2005).

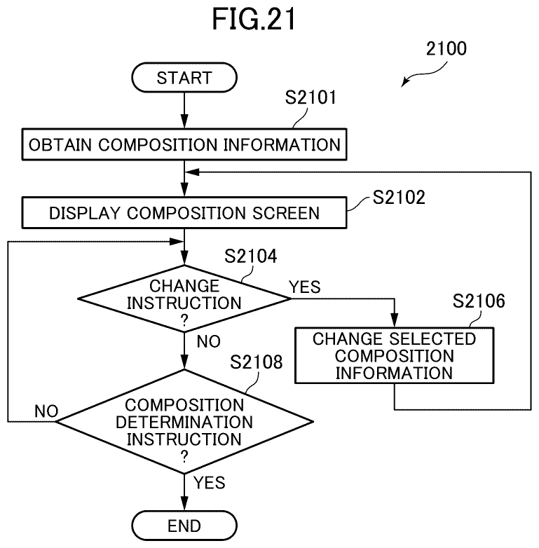

FIG. 21 shows an example composition-information determination process. The server 20 obtains composition information from the storage unit 46, the composition information being determined on the basis of whether the battle against the enemy character selected by the player is first-type content or second-type content, and transmits the composition information to the player terminal 10. Here, since the battle is second-type content, composition information including selected first-type composition information and selected second-type composition information is obtained, and the composition information is transmitted to the player terminal 10 as screen information for displaying these items of information in the first and second composition areas (S2101).

On the basis of the screen information obtained, the player terminal 10 causes the display unit 32 to display a screen for determining selected composition information (S2102). An example screen for determining selected composition information is shown in FIG. 14. Upon accepting an instruction for changing the selected composition information according to a player input (S2104), the player terminal 10 changes the selected composition information (S2106). In the case where the player input is a change instruction for the first composition area, processing for changing selected first-type composition information is executed. In the case of a change instruction for the second composition area, processing for changing selected second-type composition information is executed.

For example, when an input to a composition-information corresponding part is performed as a change instruction for the first composition area, an instruction for changing the selected first-type composition information to first-type composition information corresponding to the specified composition-information corresponding part is transmitted from the player terminal 10 to the server 20. The game control unit 44 of the server 20, having received the change instruction, sets the first-type composition information specified in the change instruction as selected first-type composition information in the storage unit 46, and reads out the new selected first-type composition information and transmits the selected first-type composition information to the player terminal 10. The player terminal 10 updates and displays the composition screen on the basis of the changed selected first-type composition information received (S2102). When an input for determining composition information is performed as a player input, the process for determining composition information is finished (S2108).

Although it is assumed here that the player terminal 10 obtains only selected composition information from the storage unit 46 of the server 20 and displays a composition screen on the basis of the selected composition information obtained, the arrangement may be such that the entirety or at least some of the composition information group associated with the player ID of the player is obtained, information indicating selected composition information is obtained, and a screen for determining selected composition information may be displayed on the basis of the selected composition information. In the case where an instruction for changing selected composition information has been accepted, it is possible to determine changed selected composition information from the composition information group stored in the player terminal 10 and to display a composition screen.

A composition information group can include image data, etc. for displaying a screen for determining selected composition information. For example, the entire composition information group obtained from the server 20 is stored in a cache of a browser or an app, which functions as the storage unit 35 of the player terminal 10, and when the selected composition information has been changed according to a player input, it is possible to read out information for new selected composition information from the cache and to display a screen. In the case where new selected composition information is not stored in the player terminal 10, new selected composition information may be obtained again from the server 20, update information may be transmitted to the server 20 each time selected composition information is changed, or determined selected composition information may be transmitted at the end of the composition process.

Furthermore, by storing the entire composition information group or at least some of the information at the player terminal 10, there is no need to carry out communication each time selected composition information is changed. Furthermore, after the end of content execution, when displaying a screen for determining selected composition information for the next content execution, it is possible to display a screen on the basis of the information stored at the player terminal 10, without having to carry out communication with the server 20.

Furthermore, also when executing an event of the first content type, it is possible to determine selected composition information for use in the event through the process shown in FIG. 21 (S1615). In this case, since the event is first-type content, there is a difference from the processing in the case of second-type content in that information displayed in both of the first and second composition areas is first-type composition information including first-type game media.

In this embodiment, an image including a first composition area and a second composition area is displayed within a single screen, and the same kinds of operational inputs are used as player inputs corresponding to the first composition area and player inputs corresponding to the second composition area. This makes it possible to select first-type and second-type composition information within a single screen, which makes it possible to reduce the number of operations and the number of screen transitions required when the player starts a content play and to realize intuitive and convenient operations.

When the process for determining composition information is finished, a battle event with the enemy character selected by the player is executed by using the composition information determined, and the second stamina value is decreased by the stamina value required for the battle (S2006). By selecting one of the selection areas 1921 to 1923 in FIG. 19, the player can transmit a command for executing a battle against the corresponding enemy character to the server 20.

Furthermore, in the case where a normal enemy character has been defeated, event-generation determination processing is executed (S2008). In the event-generation determination processing, whether or not a colored enemy character and a treasure box, which occur with prescribed probabilities, are to occur through lottery processing using random numbers. The colored enemy character or treasure box that has been determined to occur are displayed as disposed on one of the squares and are displayed on the corresponding square in the game screen shown in FIG. 19.

In the case where the event is not a battle against a normal enemy character, it is determined whether or not the event is a battle against a colored enemy character (S2010). In the case of a battle against a colored enemy character, after determining selected composition information through processing similar to that in S2005 (S2011), the battle against the colored enemy character is executed, whereby the required stamina is consumed (S2012). Then, whether or not to generate a bonus time is determined through lottery processing (S2014).

In the case where the event is not a battle against a colored enemy character either, the event selected by the player is an event for opening a treasure box, and thus processing for opening the treasure box is executed (S2016). Since there are cases where a plurality of treasure boxes have occurred, it is assumed that processing for opening a treasure box selected by the player is executed. In the treasure-box opening processing, processing for determining whether or not a treasure-box enemy character associated with the opening of the treasure box is to appear, as well as processing for consuming the stamina necessary for executing lottery processing for an item to occur, are executed.

Then, it is determined whether or not a treasure-box enemy character associated with the opening of the treasure box has appeared (S2018). In the case where a treasure-box enemy character has not appeared, the item determined through a lottery is acquired by the player (S2022), and information concerning player parameters is updated. In the case where it is determined that a treasure-box enemy character has appeared, after determining selected composition information through processing similar to that in S2005 (S2023), a battle against the enemy character that has appeared is executed (S2024). In the case where the enemy character is defeated through the battle, the second stamina value is recovered by an amount corresponding to the stamina value consumed as a result of opening the treasure box. The arrangement may be such that it is possible to acquire an item determined through a lottery also in the case where the enemy character is defeated.

It is possible to dispose a recovery-item use instruction area in each of the screens in FIGS. 17 to 19. In response to the player selecting the area, a screen for selecting whether to use the recovery item A or the recovery item B is displayed on the player terminal 10. Upon accepting a user input for selecting a recovery item, a screen for selecting whether the first stamina value or the second stamina value is to be used is displayed. Upon accepting a user input for selecting the stamina value to use, a recovery-item use command including information indicating the recovery item to use and the stamina value to use is transmitted to the server 20. This makes it possible to execute processing for recovering the first or second stamina value, selected as the stamina value to use, by using the selected recovery item. The stamina recovery processing is the same as that in S1614 or S1664.

The arrangement may be such that the processing for determining whether or not the current stamina value of the player is greater than or equal to the stamina value required for the selected event to be executed (S1608 and S1658), as well as the processing for displaying a prompt for a recovery-item use instruction (S1610 and S1660), are executed at the player terminal 10, and such that whether or not the current stamina value of the player can be used is determined again at the server 20 before the event execution processing (S1616 and S1666). The arrangement may be such that if it is determined by the server 20 that the stamina value of the player is greater than or equal to the required stamina value, the event is executed while subtracting the required stamina value, while if the stamina value is less than the required stamina value, an instruction for executing the processing for displaying a prompt for a recovery-item use instruction (S1610 and S1660) is transmitted to the player terminal 10, or an indication that it is not possible to execute the event due to insufficient stamina is displayed on the player terminal 10, and the process returns to displaying of the event selection screen (S1602 and S1652).

In the case where there are a plurality of items of content, it is a practice to set different kinds of stamina values for the individual items of content and to set special recovery items for the individual stamina values. In such cases, the player has to learn which recovery items are applicable to which stamina values, which makes the system complex for the player, possibly compromising the motivation for playing the game.

With this embodiment, it is possible to use a common recovery item even in the case where different kinds of stamina values are consumed for individual items of content. This is easily understandable for the player, which makes it possible to provide a game with less burden.

Furthermore, with recent online games using smartphones, the same online game is continuously played by a large number of players over a few years. In order to maintain the players' motivation for playing, the provider of such an online game sometimes add new content to existing content in the same online game. For players who already possess a large number of recovery items collected by playing existing content over a long period, if it is necessary to collect new recovery items again for playing the new content, the motivation for playing the new content might be compromised, which might result in the loss of the motivation for playing the online game itself.

With this embodiment, by using a common recovery item for recovering the stamina value required for executing newly added content and for recovering the stamina value required for executing existing content, it is possible to use an already possessed recovery item for the new content, and it becomes possible to enhance the motivation for playing the new content and to maintain the motivation for playing the whole online game.

In one modification, third content that is executed by consuming a third stamina value is further included. Upon accepting another-recovery-item use command for using another recovery item different from the recovery items for recovering the first and second stamina values, it is possible to recover the third stamina value.

In the case where an event in first content that has already been started and is being executed by the player and another player participates in the event, the event can be considered as an event in third content. For example, it is assumed that, as an event in first content, a multi-battle, in which a large number of players cooperatively play a battle against a common enemy character, is included. In the case where the player performs a user input for starting a multi-battle and the execution of the battle is started, an amount of the first stamina value of the player, corresponding to the stamina value required for starting and executing the multi-battle, is consumed. Meanwhile, a player who has performed a user input for participating in a multi-battle started by another player consumes an amount of the third stamina value of the player, corresponding to the stamina value required for participating in and executing the multi-battle.

The amount of the first stamina value consumed in the case of starting and executing a multi-battle and the amount of the third stamina value consumed in the case of participating in and executing a multi-battle are different amounts. As yet another modification, the third stamina value may be consumed also in the case of starting and executing a multi-battle.

In another embodiment of the present invention, the player terminal 10 may be a game control device. Another embodiment of the present invention may be a program for realizing the functions, or the information processing shown in the flowcharts, of the above-described embodiment of the present invention, or a computer-readable storage medium storing the program. Furthermore, another embodiment may be a method for realizing the functions, or the information processing shown in the flowcharts, of the above-described embodiment of the present invention.

The processing or operation described above may be modified freely as long as no inconsistency arises in the processing or operation, such as an inconsistency that a certain step utilizes data that may not yet be available in that step. Furthermore, the examples described above are examples for explaining the present invention, and the present invention is not limited to those examples. The present invention can be embodied in various forms as long as there is no departure from the gist thereof.

### REFERENCE SIGNS LIST

1 Game system

2 Network

10 Player terminal

11 Processor

12 Display device

13 Input device

14 Storage device

15 Communication device

16 Bus

20 Server

21 Processor

22 Display device

23 Input device

24 Storage device

25 Communication device

26 Bus

31 Input unit

32 Display unit

33 Communication unit

34 Game control unit

35 Storage unit

41 Input unit

42 Display unit

43 Communication unit

44 Game control unit

45 Stamina management unit

46 Storage unit

1. A system for a game in which content is executed by using a game medium composition including a plurality of game media, wherein:
the system stores a first-type game medium group including two or more first-type game media, a second-type game medium group including two or more second-type game media, first-type composition information indicating compositions each including two or more first-type game media selected from among the first-type game media, second-type composition information indicating compositions each including two or more second-type game media selected from among the second-type game media, a first-type composition information group including two or more items of first-type composition information, and a second-type composition information group including two or more items of second-type composition information;
the system displays a composition image showing a first composition area and a second composition area, the first composition area being an area for displaying selected first-type composition information selected from the first-type composition information group for the purpose of use in content, and the second composition area being an area for displaying selected second-type composition information selected from the second-type composition information group;
the system changes the selected first-type composition information on the basis of a player input corresponding to the first composition area, and changes the selected second-type composition information on the basis of a player input corresponding to the second composition area; and
the system executes content on the basis of the selected first-type composition information and the selected second-type composition information.

2. A system according to claim 1, wherein:
the first-type game media are used in order to execute content of a first content type and content of a second content type, and the second-type game media are used in order to execute content of the second content type;
the composition image is generated on the basis of content to be executed, selected by a player, and in the case where the content to be executed is first-type content, other selected first-type composition information selected from the first-type composition information group or first-type game media are displayed in the second composition area instead of the selected second-type composition information; and
the execution of content is executing the content to be executed, selected by the player.

3. A system according to claim 2, wherein the content of the first content type is content that is executed on the basis of the consumption of a first parameter associated with a player, and the content of the second content type is content that is executed on the basis of the consumption of a second parameter associated with a player.

4. A system according to claim 1, wherein the player input corresponding to the first composition area and the player input corresponding to the second composition area are the same kind of operational input.

5. A system according to claim 1, wherein:
the changing of the selected first-type composition information includes changing the selected first-type composition information to other first-type composition information in the first-type composition information group; and
the changing of the selected second-type composition information includes changing the selected second-type composition information to other second-type composition information in the second-type composition information group.

6. A method for a game in which content is executed by using a game medium composition including a plurality of game media, wherein a computer is caused to:
store a first-type game medium group including two or more first-type game media, a second-type game medium group including two or more second-type game media, first-type composition information indicating compositions each including two or more first-type game media selected from among the first-type game media, second-type composition information indicating compositions each including two or more second-type game media selected from among the second-type game media, a first-type composition information group including two or more items of first-type composition information, and a second-type composition information group including two or more items of second-type composition information;
transmit information for displaying a composition image showing a first composition area and a second composition area, the first composition area being an area for displaying selected first-type composition information selected from the first-type composition information group for the purpose of use in content, and the second composition area being an area for displaying selected second-type composition information selected from the second-type composition information group;
change the selected first-type composition information on the basis of a player input corresponding to the first composition area and change the selected second-type composition information on the basis of a player input corresponding to the second composition area; and
execute content on the basis of the selected first-type composition information and the selected second-type composition information.

7. A method for a game in which content is executed by using a game medium composition including a plurality of game media, wherein a computer is caused to:
display a composition image on the basis of information obtained from a storage medium storing a first-type game medium group including two or more first-type game media, a second-type game medium group including two or more second-type game media, first-type composition information indicating compositions each including two or more first-type game media selected from among the first-type game media, second-type composition information indicating compositions each including two or more second-type game media selected from among the second-type game media, a first-type composition information group including two or more items of first-type composition information, and a second-type composition information group including two or more items of second-type composition information, the composition image showing a first composition area and a second composition area, the first composition area being an area for displaying selected first-type composition information selected from the first-type composition information group for the purpose of use in content, and the second composition area being an area for displaying selected second-type composition information selected from the second-type composition information group;
change the selected first-type composition information on the basis of a player input corresponding to the first composition area and change the selected second-type composition information on the basis of a player input corresponding to the second composition area; and
execute content on the basis of the selected first-type composition information and the selected second-type composition information.

8. A non-transitory computer readable medium storing a program for causing a computer to execute a method according to claim 6.

9. A non-transitory computer readable medium storing a program for causing a computer to execute a method according to claim 7.

10. An information processing device for a game in which content is executed by using a game medium composition including a plurality of game media, wherein:
the information processing device stores a first-type game medium group including two or more first-type game media, a second-type game medium group including two or more second-type game media, first-type composition information indicating compositions each including two or more first-type game media selected from among the first-type game media, second-type composition information indicating compositions each including two or more second-type game media selected from among the second-type game media, a first-type composition information group including two or more items of first-type composition information, and a second-type composition information group including two or more items of second-type composition information;
the information processing device transmits information for displaying a composition image showing a first composition area and a second composition area, the first composition area being an area for displaying selected first-type composition information selected from the first-type composition information group for the purpose of use in content, and the second composition area being an area for displaying selected second-type composition information selected from the second-type composition information group;
the information processing device changes the selected first-type composition information on the basis of a player input corresponding to the first composition area, and changes the selected second-type composition information on the basis of a player input corresponding to the second composition area; and
the information processing device executes content on the basis of the selected first-type composition information and the selected second-type composition information.

11. An information processing device for a game in which content is executed by using a game medium composition including a plurality of game media, wherein:
the information processing device displays a composition image on the basis of information obtained from a storage medium storing a first-type game medium group including two or more first-type game media, a second-type game medium group including two or more second-type game media, first-type composition information indicating compositions each including two or more first-type game media selected from among the first-type game media, second-type composition information indicating compositions each including two or more second-type game media selected from among the second-type game media, a first-type composition information group including two or more items of first-type composition information, and a second-type composition information group including two or more items of second-type composition information, the composition image showing a first composition area and a second composition area, the first composition area being an area for displaying selected first-type composition information selected from the first-type composition information group for the purpose of use in content, and the second composition area being an area for displaying selected second-type composition information selected from the second-type composition information group;
the information processing device causes the selected first-type composition information to be changed on the basis of a player input corresponding to the first composition area, and causes the selected second-type composition information to be changed on the basis of a player input corresponding to the second composition area; and
the information processing device causes content to be executed on the basis of the selected first-type composition information and the selected second-type composition information.
